(19) United States
(12) Patent Application Publication
(10) Pub. No.: US 2020/0005378 A1
(43) Pub. Date: Jan. 2, 2020

(54) SYSTEM, DEVICE, AND MOBILE APPLICATION TO FACILITATE GROCERY SHOPPING AT A GROCERY STORE

(71) Applicant: Blake Anderson, Duncombe, IA (US)

(72) Inventor: Blake Anderson, Duncombe, IA (US)

(21) Appl. No.: 16/021,038

(22) Filed: Jun. 28, 2018

(51) Int. Cl. G06Q 30/06; G06Q 30/02; G01C 21/20

(52) U.S. Cl. CPC G06Q 30/0625; G01C 21/206; G06Q 30/0281

(57) ABSTRACT

A system having a mobile application running thereon to facilitate grocery shopping at a grocery store, the system including a storage unit to store data related to the grocery store, and a first apparatus including an input unit to allow the user to input a request to locate a particular item in the grocery store, and a display unit to display a map of an inside of the grocery store and a blinking beacon dot to show exactly where the particular item is located within the grocery store, based on the user's request and the store data stored within the storage unit.

### BACKGROUND

### 1. Field

The present general inventive concept relates generally to a system, device, and a mobile application executed on the device to facilitate grocery shopping at a grocery store.

### 2. Description of the Related Art

Whether pressed for time, sick of coupon-clipping, or can't seem to remember that one last ingredient, grocery shopping can feel more difficult than it should be. Writing out a list on paper or on a phone can be helpful, but that hardly prevents one from feeling lost when searching around the store for specific items when unfamiliar with aisle structuring.

Therefore, there is a need for a device and a mobile application executed on the device to facilitate grocery shopping at a grocery store.

### SUMMARY

The present general inventive concept provides a device and a mobile application executed on the device to facilitate grocery shopping at a grocery store.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a system having a mobile application running thereon to facilitate grocery shopping at a grocery store, the system including a storage unit to store data related to the grocery store, and a first apparatus including an input unit to allow the user to input a request to locate a particular item in the grocery store, and a display unit to display a map of an inside of the grocery store and a blinking beacon dot to show exactly where the particular item is located within the grocery store, based on the user's request and the store data stored within the storage unit.

The system may further include a network to allow communication between the storage unit and the first apparatus.

The storage unit may update a cost of the desired item based on data provided by the network or an administrator.

The first device may be a mobile telephone to communicate with a second device via the network.

The data related to the grocery store may include at least one of location of a particular grocery store, inventory of the particular grocery store, aisle numbers within the grocery store, and item locations within the grocery store with respect to aisles and locations within the aisles.

The display unit may further display another beacon to demarcate a position of the user with respect to the desired item.

The user may input a name of the particular item or a type of the particular item using the input unit.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a system to facilitate grocery shopping at a grocery store, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

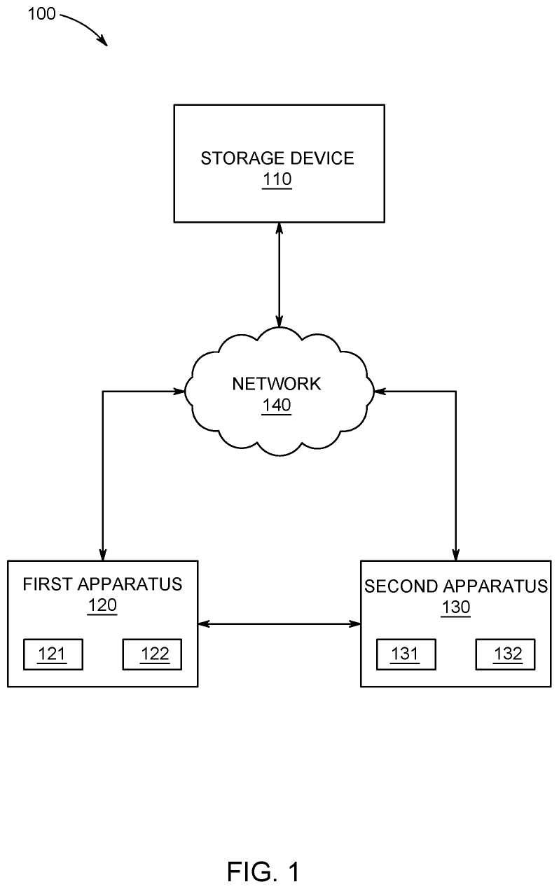

FIG. 1 illustrates a system 100 to facilitate grocery shopping at a grocery store, according to an exemplary embodiment of the present general inventive concept.

The system 100 may include a storage device 110, a first apparatus 120, a second apparatus 130, and a network 140, but is not limited thereto.

Herein, a customer may use the first apparatus 120 to find a particular item in a store via a mobile and/or software application executed on the first apparatus 120, and may also utilize the via a mobile and/or software application to communicate with another customer using the second apparatus 130 to inform the another customer about a location of the particular item. As such, the mobile and/or software application executed on the first apparatus 120 may be an “app” having an account connected thereto that may be utilized by multiple apparatuses.

The storage device 110 may include a server, a computing device with a storage unit, and a cloud-based storage space, but is not limited thereto. The storage device 110 may store a plurality of information regarding grocery stores, including, but not limited to, at least one of location of a particular grocery store, inventory of the particular grocery store, aisle numbers within the grocery store, and item locations within the grocery store with respect to aisles and locations within the aisles. The information regarding grocery stores may be uploaded and/or updated to and/or within the storage device 110 by an administrator of the grocery store using a computing device (such as a mobile phone, computer, etc.), but is not limited thereto, and may also be uploaded and/or updated by a manager.

The storage device 110 may also communicate with the first apparatus 120 via the network 140 and the mobile and/or software application executed on the first apparatus 120, in order to send information stored within the storage device 110 to the first apparatus 120 based on a user's request.

The first apparatus 120 may include a computing device that may receive input, transmit data, receive data, access the Internet, provide global positioning services (GPS), and communicate with other devices or systems via a network, and may include a desktop computer, a laptop computer, a tablet computer, or a mobile device, such as a cellular phone or a smart phone, but is not limited thereto.

The first apparatus 120 may access the Internet (e.g., the network 140) to allow a user to access the storage unit 110 when the user wants to find a particular item in the grocery store. The first apparatus 120 may also have stored thereupon a software application that allows the user to find babysitters corresponding to criteria specified by the user, such as proximity, availability, cost, coupons, etc. Also, the software application may have information regarding the desired item at various stores located near the user, which are all accessible by the first apparatus 120. The storage unit 110 may be automatically updated when there are various sales.

Also, the storage unit 110 may sense when the use is actually within a particular store, and may send data related to the particular store when the user sends input request for particular items.

The first apparatus 120 may include an input unit 121 to allow the user to input data into the first apparatus 120, and a display unit 122 to allow the user to view data displayed on the display unit 122.

Specifically, the user may use the input unit 121 to type in a name of a desired item, such as, “Cheerios,” “Brawny,” and “Snuggle,” or alternatively, a type of an item, such as “Cereal”, Paper Towels,” “Fabric Softener,” and “Carrot,” and the first apparatus 120 may access the storage unit 110 via the network in order to find the specified item within the store.

Also, the user may use the input unit 121 to substantiate a particular store and location where the user desires to conduct the search, even if the user is not in the particular store.

The user may also input a list of desired items into the input unit 121, and then send the list to the second apparatus 130 so that the list may be shared with a second user using the second apparatus 130.

The first apparatus 120 may utilize global positioning (GPS), and item tracking technology, in order to allow the user to track a particular desired in a particular grocery store, and then locate the item specifically with respect to the aisle number, row number within the aisle, and position of the item within the row.

In fact, the display unit 122 may display a map of the grocery store, based on the user's request, and a blinking beacon dot to show exactly where a desired item is located within the grocery store. The display unit may also display another beacon to demarcate a position of the user with respect to the desired item within the grocery store. As such, the user may walk in the store in the direction of the desired item, while being directed audibly by a GPS map direction guidance audio aid. Therefore, the user may walk in the direction of the desired item while being told various directions, such as, “make a right at aisle two,” walk about fifteen fee,” “turn left,” “your item will be on the third shelf from the bottom.”

Alternatively, the display unit 122 may display the directions in written form, so that the user may read the directions to find the desired item instead of hearing them.

The second apparatus 130 may communicate with the first apparatus 120, and may include similar components in order to execute the mobile application and access the storage unit 110.

The second apparatus 130 may include an input unit 131 to allow the user to input data into the second apparatus 130, and a display unit 132 to allow the user to view data displayed on the display unit 132, similarly to the first apparatus 120.

The software application stored on the first apparatus 120 may include a GPS map viewable on the display unit 122, which is always current and updated.

Referring to FIG. 1, the network 140 may be at least one of the Internet, a cellular network, a universal mobile telecommunications systems (UMTS) network, a Long Term Evolution (LTE) network, a Global System for Mobile Communications (GSM) network, a local area network (LAN), a virtual private network (VPN) coupled to the LAN, a private cellular network, a private telephone network, a private computer network, a private packet switching network, a private line switching network, a private wide area network (WAN), a corporate network, or any number of private networks that can be referred to as an Intranet. The network 140 can be implemented with any number of hardware and software components, transmission media, and network protocols. FIG. 1 illustrates the network 140 as a single network, but is not limited thereto.

The first apparatus 120 and the second apparatus 130 can both can send data to, and receive data from, the storage device 110 over via the Internet or any of the above-mentioned networks. The first apparatus 120 and the second apparatus 130 can be directly coupled to the storage device 110. Alternatively, the first apparatus 120 and the second apparatus 130 can be connected to the storage device 110 via any other suitable device, communication network, or combination thereof. For example, the first apparatus 120 can be coupled to the storage device 110 via routers, switches, access points, and/or communication networks. In other words, the storage device 110, the apparatus 120, and the apparatus 130 may all communicate with each other via the network 140.

The mobile application running on the first apparatus 120 may be called the “Shopping Buddy,” but is not limited thereto, and may include a mobile application (i.e., app) to make shopping experiences easier. Specifically, the Shopping Buddy is an app that allows users to create a shopping list and select the store they will be shopping in to find items in a more efficient and effective way. Utilizing the optional GPS system, customers are navigated to each product in the store all the way to the specific location of the item in the aisle and include a map that routes users to the most competent path to retrieve their items when their grocery list is extensive. The Shopping Buddy offers a share feature where users can notify or send a copy of the grocery list to another person in their household to pick up items while at the store, allowing more than one person to be signed into the app on an account connected to the first apparatus 120.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A system having a mobile application running thereon to facilitate grocery shopping at a grocery store, the system comprising:
a storage unit to store data related to the grocery store; and
a first apparatus comprising:
an input unit to allow the user to input a request to locate a particular item in the grocery store; and
a display unit to display a map of an inside of the grocery store and a blinking beacon dot to show exactly where the particular item is located within the grocery store, based on the user's request and the store data stored within the storage unit.

2. The system of claim 1, further comprising:
a network to allow communication between the storage unit and the first apparatus.

3. The system of claim 2, wherein the storage unit updates a cost of the desired item based on data provided by the network or an administrator.

4. The system of claim 2, wherein the first device is a mobile telephone to communicate with a second device via the network.

5. The system of claim 1, wherein the data related to the grocery store includes at least one of location of a particular grocery store, inventory of the particular grocery store, aisle numbers within the grocery store, and item locations within the grocery store with respect to aisles and locations within the aisles.

6. The system of clam 1, wherein the display unit further displays another beacon to demarcate a position of the user with respect to the desired item.

7. The system of claim 1, wherein the user may input a name of the particular item or a type of the particular item using the input unit.
